(19) United States
(12) Patent Application Publication
(10) Pub. No.: US 2006/0018224 A1
(43) Pub. Date: Jan. 26, 2006

(54) Optical recording/reproducing apparatus for CLV error recovery and method thereof

(75) Inventor: Kyu-chul Bang, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/183,958

(22) Filed: Jul. 19, 2005

(30) Foreign Application Priority Data
Jul. 24, 2004 (KR) 2004-57897

(51) Int. Cl. G11B 5/09

(52) U.S. Cl. 369/47.48; 369/47.36

(57) ABSTRACT

Disclosed are an optical recording/reproducing apparatus for a CLV error recovery and a method thereof that can recover from a CLV error in a short time. The apparatus includes a spindle motor control unit for controlling a rotating speed of a spindle motor and comparing the present rotating speed of the spindle with a specified speed, a pickup unit, a signal conversion unit for receiving and converting an output signal of the pickup unit into a digital signal, and generating a judgment signal for determining whether a spindle control is normally performed, a sync signal generation unit for receiving the judgment signal and determining whether the spindle control is normally performed, a storage unit for storing position values of the disk and rotating speed values of the spindle at the positions of the disk in a table, and a control unit for controlling the spindle motor control unit to change the rotating speed of the spindle according to a comparison result obtained by the spindle motor control unit and a judgment result obtained by the sync signal generation unit.

### CROSS-REFERENCE TO RELATED APPLICATIONS

This application claims the benefit of Korean Patent Application No. 2004-57897, filed on Jul. 24, 2005, in the Korean Intellectual Property Office, the disclosure of which is incorporated herein by reference.

### BACKGROUND OF THE INVENTION

1. Field of the Invention

The present invention relates to an optical recording/reproducing apparatus for recovery of a CLV (Constant Linear Velocity) error and a method thereof. More particularly, the present invention relates to an optical recording/reproducing apparatus for a CLV error recovery and a method thereof that can recover from a CLV error in a short time.

2. Description of the Related Art

Generally, an optical recording/reproducing apparatus for recording/reproducing data in/from an optical disk such as a CD (Compact Disk), a DVD (Digital Versatile Disk), etc., performs a low-speed control operation when it records/reproduces a signal. This is because noise occurring due to an excessive current change is reduced as the signal reproduction is performed at a lower speed. Additionally, as the reproduction speed of a high-frequency signal is heightened, the reproduced signal deteriorates, and this affects the stability of a system. Accordingly, a low-speed control is required in reproducing the signal.

Generally, a CLV (Constant Linear Velocity) rotating system is used as a disk rotating system that controls a low-speed recording/reproduction of data. If the CLV system is used, the data processing speed is controlled to be constant on an inner/outer periphery of the disk. This CLV system makes it possible to record/reproduce data by rotating the disk at a constant linear speed, and thus, the density of the data being recorded/reproduced is kept constant irrespective of the inner/outer periphery of the disk, resulting in a high-density data being stored.

However, if the CLV system is used when the data is reproduced from the optical disk at high speed, many problems occur due to the high rotating speed on the inner periphery of the disk and the increase of the power consumption. In order to overcome these problems, a CAV (Constant Angular Velocity) system for rotating the disk with the constant number of rotations using a wideband PLL (Phase Locked Loop) and a buffer control has been used together with the CLV system. Unlike the CLV system, the CAV system controls the rotating speed of the disk to be constant, and thus, the processing speed of data on the inner periphery of the disk differs from that on the outer periphery of the disk.

If the CLV is not maintained due to an external factor and a CLV system that can store high-density data is used, i.e., if a linear speed cannot be kept constant, the data that is recorded to match the linear speed cannot be read out from the disk, and this causes the system operation such as the data recording, reproduction, etc., to be stopped. In this case, a search operation for moving the pickup to a desired position on the disk is performed.

FIG. 1 is a flowchart explaining a method for recovery of a CLV error occurring during the search operation in a conventional optical recording/reproducing apparatus. In FIG. 1, a search starts to move a pickup to its desired position on a disk at operation 101. For the CLV control at the desired position on the disk, the present mode is changed from a CLV mode to a CAV mode, and the rotating speed of a spindle is changed so as to match the CLV at the position to which the pickup will move at operation 103. This operation is performed using a CAV speed table prepared to store the speed value that is equal to the CLV speed at a specified position of the disk. Then, the pickup moves to the desired position by driving a step motor at operation 105.

Then, it is determined whether the pickup has moved to the desired position, i.e., whether a CLV error has occurred by reading the data stored at the position to which the pickup has moved at operation 107.

If no CLV error occurs, the present mode is changed from the CAV mode to the CLV mode, and the data recorded at the position to which the pickup has moved is read out. If no CLV error occurs, it means that the data of the desired position has been read, and thus, the CLV error recovery is not required.

By contrast, if the CLV error has occurred, the pickup returns to its initial position, and the spindle is rotated to match the initial position of the pickup at operation 109. At this time, the CLV error occurs if the pickup fails to move to the desired position due to problems such as the deterioration of a sled motor, scratch or tilt of the disk, etc. Additionally, the CLV error may occur if the spindle cannot perform a normal operation due to the deterioration of a spindle motor that drives the spindle. After the pickup moves to its initial position and the rotating speed of the spindle is set to an initial speed, the present mode is changed to a CLV mode to read the data at a constant linear speed at operation 111.

At operation 113, if it is determined that the data at the desired position cannot be read, the pickup moves again to its initial position, and the same operation is repeated. However, if it is determined that the data at the desired position is read, it means that the CLV error recovery has been performed.

However, in the optical recording/reproducing apparatus that requires a realtime system, the conventional method for a CLV error recovery has the problems in that it takes a lot of time to perform its initialization work in order to move the pickup to its initial position and then to rotate the disk.

Additionally, if the rotating speed of the spindle and the position of the pickup do not coincide with values that should be set in its initialization process due to external environmental factors or an internal factor such as the deterioration of the spindle motor or the sled motor, the mode is not changed to the CLV mode, and thus the system cannot be initialized.

### SUMMARY OF THE INVENTION

The present invention has been developed in order to solve the above drawbacks and other problems associated with the conventional arrangement. Accordingly, it is an aspect of the present invention is to provide an optical recording/reproducing apparatus for a CLV error recovery and a method thereof that would recover from a CLV error in that the data of the desired position cannot be read in a short time.

The foregoing and/or other aspects and advantages are achieved by providing an optical recording/reproducing apparatus for a CLV (Constant Linear Velocity) error recovery, according to the present invention, which includes a spindle motor control unit for controlling a rotating speed of a spindle motor that rotates a disk and comparing the present rotating speed of the spindle with a specified speed, a pickup unit for irradiating beams onto the disk, receiving the beams reflected from the disk and outputting a corresponding RF signal, a signal conversion unit for receiving and converting the signal output from the pickup unit into a digital signal, and generating a judgment signal for determining whether a spindle control is normally performed, a sync signal generation unit for receiving the judgment signal and determining whether the spindle control is normally performed, a storage unit for storing position values of the disk and rotating speed values of the spindle at the positions of the disk in a table, and a control unit for controlling the spindle motor control unit to change the rotating speed of the spindle according to a comparison result obtained by the spindle motor control unit and a judgment result obtained by the sync signal generation unit.

The control unit operates to store the present rotating speed of the spindle and a present data position in the storage unit if the present rotating speed of the spindle is equal to the rotating speed of the spindle stored in the storage unit and the spindle control is normally performed. Meanwhile, the control unit controls the spindle motor control unit to change the rotating speed of the spindle if the present rotating speed of the spindle is different from the rotating speed of the spindle stored in the storage unit.

Here, the specified speed is any one of the rotating speed values of the spindle stored in the storage unit according to the specified position of the disk.

In another aspect of the present invention, there is provided a method for a CLV (Constant Linear Velocity) error recovery in an optical recording/reproducing apparatus, which includes determining whether a spindle control is normally performed if a CLV error occurs in the optical recording/reproducing apparatus, comparing a present rotating speed of the spindle with a specified speed if the spindle control is not normally performed, determining whether the spindle control is normally performed if the present rotating speed of the spindle is equal to the specified speed, and reading a data position of the disk if the spindle control is normally performed.

In still another aspect of the present invention, there is provided a method for a CLV (Constant Linear Velocity) error recovery in an optical recording/reproducing apparatus including determining whether a spindle control is normally performed by evaluating whether a present rotating speed of the spindle is equal to a specified speed.

Here, the specified speed is the rotating speed of the spindle at a specified position of the disk, and the rotating speed of the spindle according to the specified position of the disk is stored in a table.

If the present rotating speed of the spindle is equal to the specified speed but the spindle control is not normally performed, then the rotating speed of the spindle is changed.

The method for a CLV error recovery according to the present invention further includes storing the read data position and the rotating speed of the spindle at the data position.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart explaining a method for recovery of a CLV error occurring during a search operation in a conventional optical recording/reproducing apparatus;

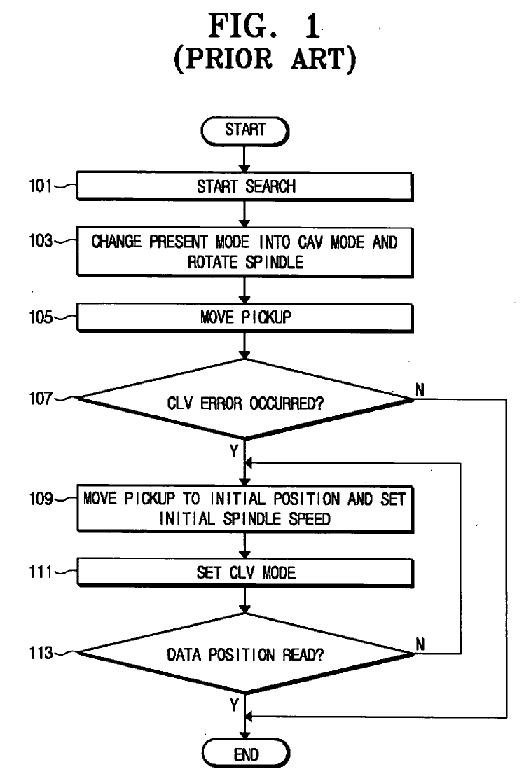

FIG. 2 is a block diagram of an optical recording/reproducing apparatus for a CLV error recovery according to an embodiment of the present invention;

FIG. 3 is a flowchart illustrating a method for a CLV error recovery in an optical recording/reproducing apparatus according to an embodiment of the present invention; and

FIG. 4 is a diagram explaining in detail a method for a CLV error recovery in an optical recording/reproducing apparatus according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures. The matters defined in the description such as a detailed construction and elements are provided to assist in a comprehensive understanding of the present invention. Thus, it is apparent that the present invention can be carried out without those defined matters. Also, well-known functions or constructions are not described in detail since they would obscure the present invention in unnecessary detail.

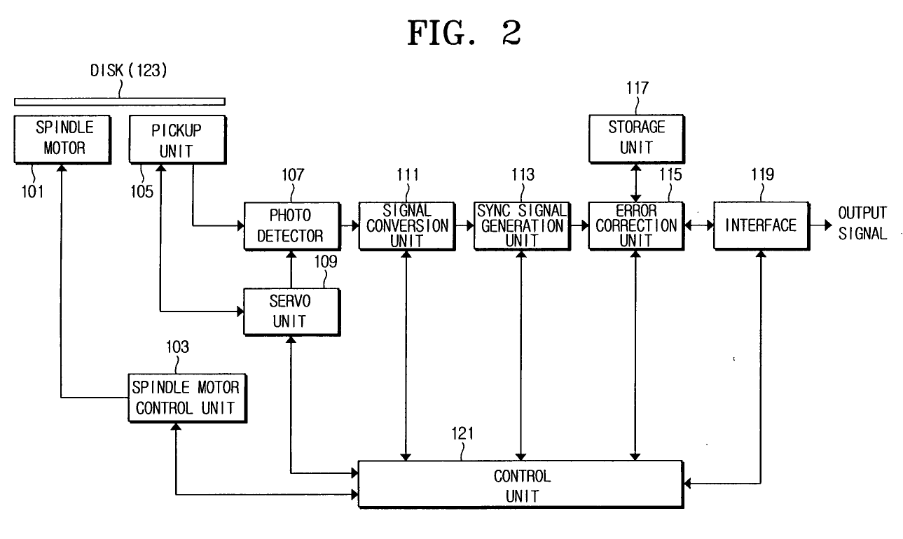

FIG. 2 is a block diagram of an optical recording/reproducing apparatus for a CLV error recovery according to an embodiment of the present invention. In FIG. 2, the apparatus for a CLV error recovery in an optical recording/reproducing apparatus according to the present invention includes a spindle motor 101, a spindle motor control unit 103, a pickup unit 105, a photo detector 107, a servo unit 109, a signal conversion unit 111, a sync signal generation unit 113, an error correction unit 115, a storage unit 117, an interface 119 and a control unit 121.

First, the spindle motor 101 rotates a disk being reproduced according to a signal for controlling the spindle motor 101. The spindle motor control unit 103 controls the operation of the spindle motor 101 according to a CLV (Constant Linear Velocity) system for keeping a constant linear velocity or a CAV (Constant Angular Velocity) system for keeping a constant angular velocity.

The pickup unit 105 irradiates beams onto a disk 123, and receives the beams reflected from the disk 123. The servo unit 109 provides information about a pickup focusing direction and a tracking direction.

The photo detector 107 receives and outputs a signal from the pickup unit 105 in the form of an RF signal. The signal conversion unit 111 receives and converts the signal output from the photo detector 107 into a digital signal, and generates a judgment signal for judging whether a spindle control is normally performed.

The sync signal generation unit 113 performs synchronization of a signal processing speed by generating a reference clock and synchronizing the processing speed of the signal output from the signal conversion unit 111 with the reference signal generated from the sync signal generation unit 113.

The error correction unit demodulates an output signal of the sync signal generation unit 115, and corrects an error occurring due to, for example, a scratch of the disk. This error correction is performed using a predetermined error code.

The storage unit 117 stores the error code used in the error correction unit 115, and provides a data processing space for the error correction performed by the error correction unit 115.

The interface unit 119 performs an operation related to a data scramble and data transmission with a host, and controls an outer buffer memory as well.

The control unit 121 controls the whole operation of the optical recording/reproducing apparatus. Particularly, the control unit 121 determines whether the operation of the sync signal generation unit 113 is normal according to the judgment signal for determining whether the spindle control is normally performed that is generated from the signal conversion unit 111.

Additionally, the control unit 121 compares the present rotating speed of the spindle with a specified speed, and controls the spindle motor control unit 103 to adjust the spindle motor 101 to make the present rotating speed equal to the specified speed.

In the control unit 121, there is a table wherein rotating speeds of the spindle according to positions of the disk 123 are stored, i.e., a table wherein data positions and speed values which are equal to CLVs at the data positions, respectively. Accordingly, if the CLV error occurs, the control unit 121 controls the spindle motor 101 to reach a specified spindle speed according to the data position using the table. The specified speed is a spindle rotating speed corresponding to the specified data position.

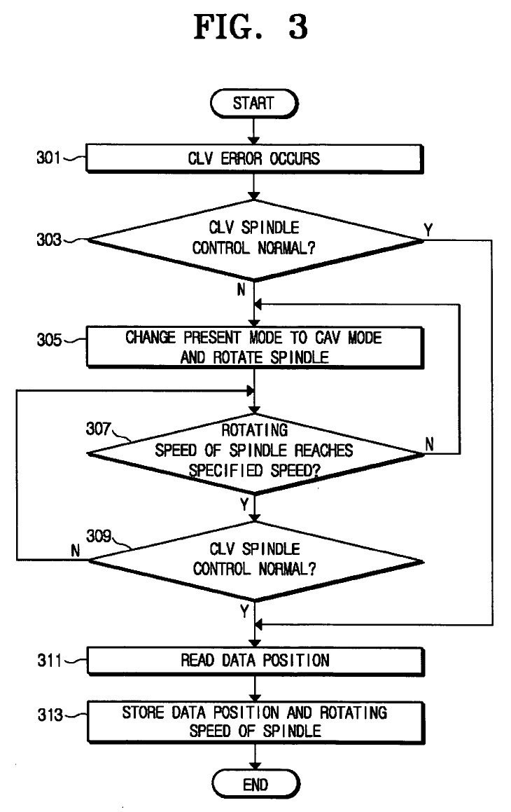

FIG. 3 is a flowchart illustrating a method for a CLV error recovery in an optical recording/reproducing apparatus according to an embodiment of the present invention.

In FIG. 3, if a CLV error occurs in the optical recording/reproducing apparatus at operation 301, it is determined whether the CLV spindle control is normally performed at operation 303. Here, the CLV error corresponds to the case in which the data of the present position of the disk 123 cannot be read. This CLV error may occur during a search operation for searching for a specified position of the disk 123 or during other normal operations for recording/reproducing data in/from the disk 123. Specifically, the CLV error occurs if the rotating speed of the spindle cannot reach the specified speed due to an abnormal operation of the spindle motor 101 or the position of the pickup cannot reach the specified position due to an abnormal operation of the sled motor.

Whether the CLV spindle control is normally performed is determined by determining whether the signal for controlling the spindle is normal through the sync signal generation unit 113. Then, in operation 305, if the CLV spindle control is not normally performed, the present mode is changed from a CLV mode to a CAV mode in order to change the speed of the spindle, and then the spindle is rotated. The rotating speed of the spindle is set using a prepared CAV speed table. In this case, the CAV speed table is a table prepared by disks and speeds, and stores data positions and speed values which are equal to CLVs at the respective data positions.

When the spindle is rotated using the CAV speed table, it is determined whether the rotating speed of the spindle reaches a specified speed stored in the CAV speed table at operation 307. Whether the rotating speed of the spindle reaches the specified speed is determined depending on whether the spindle rotating speed judgment signal is in a high state.

At this time, the state of the spindle rotating speed judgment signal is determined by comparing the rotating speed of the spindle sensed by a sensor (not illustrated) for sensing the rotating speed of the spindle with the rotating speed of the spindle in the CAV speed table stored in the control unit 121. That is, if the present rotating speed of the spindle sensed by the sensor is equal to the rotating speed in the CAV speed table, the spindle rotating speed judgment signal is in a high level, and otherwise, the spindle rotating speed judgment signal is in a low level.

The rotating speed of the spindle is increased until the sensed rotating speed of the spindle reaches the specified speed stored in the CAV speed table. If the rotating speed of the spindle reaches the specified speed, it is determined whether the CLV spindle control is normally performed at operation 309.

If the CLV spindle control is normally performed, the data position is read from the disk at operation 311. If the CLV spindle control is normally performed and the rotating speed of the spindle reaches the specified speed, it means that the recovery of the CLV error is completed, and thus, the data at the present position is read.

Then, the data read position and the rotating speed of the spindle at the data position are stored in the CAV speed table to update the CAV speed table value at operation 313. Accordingly, in the event that the existing CAV speed table is improper due to the deterioration of the spindle motor 101 or the sled motor that operates the pickup, the CAV speed table can easily be upgraded.

By contrast, if the spindle control is not normally performed although the rotating speed of the spindle reaches the specified speed, the rotating speed of the spindle is changed again, until the rotating speed of the spindle reaches the specified speed in the CAV speed table at operation 307. This operation is repeated until the CLV spindle control is normally performed.

If the CLV spindle control is normally performed at operation 303, this means that no CLV error occurs. Thus, the data position is read at operation 311, and the data position and the rotating speed of the spindle at this data position are stored at operation 313.

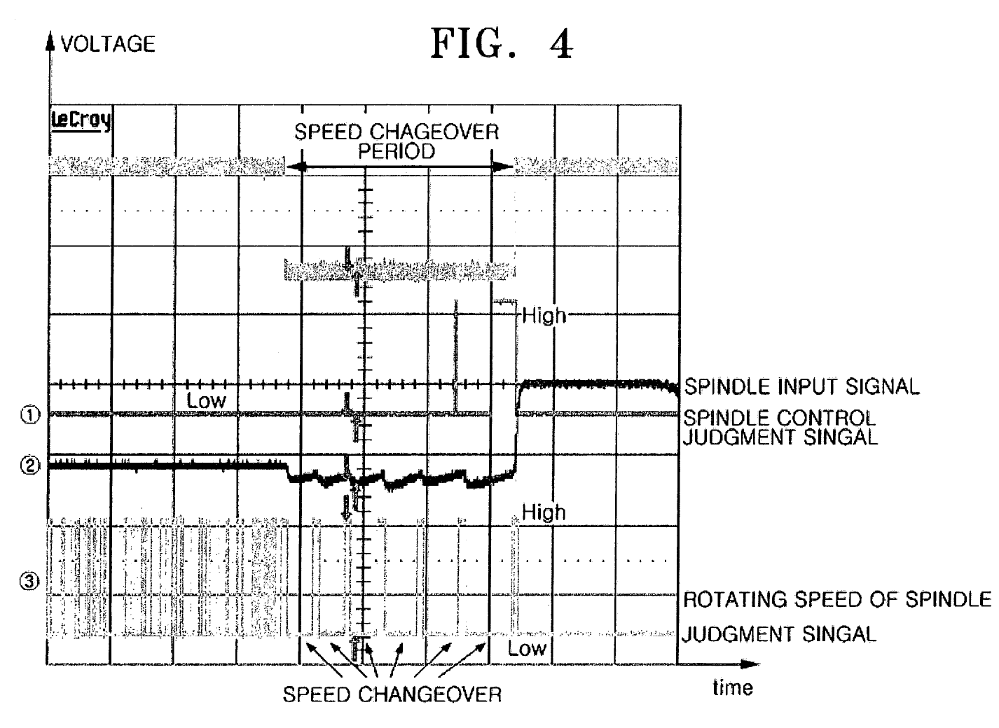

FIG. 4 is a diagram explaining in detail a method for a CLV error recovery in an optical recording/reproducing apparatus according to an embodiment of the present invention. In FIG. 4, \textcircled{1} indicates a spindle control judgment signal, \textcircled{2} a spindle input signal, and \textcircled{3} a spindle rotating speed judgment signal, respectively. Additionally, the horizontal axis represents time, and the vertical axis represents voltage level.

In FIG. 4, the spindle control judgment signal \textcircled{1} is a signal for judging whether the spindle operates normally, and is generated by the signal conversion unit 111. The sync signal generation unit 113 determines whether the spindle control is normally performed according to the spindle control judgment signal. If it is determined that the spindle control judgment signal \textcircled{1} is normal, then it is set to a high level state, and if not, it is set to a low level state.

The spindle rotating speed judgment signal \textcircled{3} is a signal for determining whether the rotating speed of the spindle reaches the specified speed and, which is one of the values stored in the CAV speed table. If the rotating speed of the spindle is equal to the specified speed in the CAV speed table, then the spindle rotating speed judgment signal \textcircled{3} is set to a high level state, and if not, the spindle rotating speed judgment signal is set to a low level state. If the spindle rotating speed judgment signal \textcircled{3} is set high but the spindle control judgment signal \textcircled{1} is low, the rotating speed of the spindle is changed. That is, as shown in FIG. 4, if the spindle rotating speed judgment signal \textcircled{3} is set high but the spindle control judgment signal \textcircled{1} is set low, the value of the spindle input signal \textcircled{2} that is inputted to the spindle for the speed control of the spindle is changed in order to change the rotating speed of the spindle. However, if both the spindle input signal \textcircled{2} and the spindle rotating speed judgment signal \textcircled{3} are all at a high level state, i.e., if the CLV error recovery is performed, the spindle input signal \textcircled{2} is not changed. That is, if both the spindle input signal \textcircled{1} and the spindle rotating speed judgment signal \textcircled{3} are all at a high level state, the CLV error recovery is performed by reading the data position, and the CAV speed table is upgraded by storing the data position and the rotating speed of the spindle at the corresponding data position.

As described above, according to the present invention, the CLV error recovery can be performed in a short time without any separate change of hardware structure in comparison to the method for recovering from the error by initializing the rotating speed and the position if the CLV error occurs.

Additionally, even if the prepared CAV speed table does not coincide with the present system operation due to the deterioration of the external environment or internal appliance, the speed table can easily be upgraded to match the system operation.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An optical recording/reproducing apparatus for a CLV (Constant Linear Velocity) error recovery, comprising:
a spindle motor control unit to control a rotating speed of a spindle motor that rotates a disk and to compare the present rotating speed of the spindle with a specified speed;
a pickup unit to irradiate beams onto the disk, to receive the beams reflected from the disk and to output a corresponding RF signal;
a signal conversion unit to receive and convert the signal output from the pickup unit into a digital signal, and to generate a judgment signal for determining whether a spindle control is normally performed;
a sync signal generation unit to receive the judgment signal and determine whether the spindle control is normally performed;
a storage unit to store position values of the disk and rotating speed values of the spindle at the positions of the disk in a table; and
a control unit to control the spindle motor control unit to change the rotating speed of the spindle according to a comparison result obtained by the spindle motor control unit and a judgment result obtained by the sync signal generation unit.

2. The optical recording/reproducing apparatus as claimed in claim 1, wherein the control unit operates to store the present rotating speed of the spindle and a present data position in the storage unit if the present rotating speed of the spindle is equal to the rotating speed of the spindle stored in the storage unit and the spindle control is normally performed.

3. The optical recording/reproducing apparatus as claimed in claim 1, wherein the control unit controls the spindle motor control unit to change the rotating speed of the spindle if the present rotating speed of the spindle is different from the rotating speed of the spindle stored in the storage unit.

4. The optical recording/reproducing apparatus as claimed in claim 1, wherein the specified speed is any one of the rotating speed values of the spindle stored in the storage unit according to the specified position of the disk.

5. A method for a CLV (Constant Linear Velocity) error recovery in an optical recording/reproducing apparatus, comprising:
determining whether a spindle control is normally performed if a CLV error occurs in the optical recording/reproducing apparatus;
comparing a present rotating speed of the spindle with a specified speed if the spindle control is not normally performed;
determining whether the spindle control is normally performed if the present rotating speed of the spindle is equal to the specified speed; and
reading a data position of the disk if the spindle control is normally performed.

6. The method as claimed in claim 5, wherein the specified speed is the rotating speed of the spindle at a specified position of the disk, and the rotating speed of the spindle according to the specified position of the disk is stored in a table.

7. The method as claimed in claim 5, wherein if the present rotating speed of the spindle is equal to the specified speed but the spindle control is not normally performed, the rotating speed of the spindle is changed.

8. The method as claimed in claim 5, further comprising storing the read data position and the rotating speed of the spindle at the data position.

9. A method for a CLV (Constant Linear Velocity) error recovery in an optical recording/reproducing apparatus, comprising:
determining whether a spindle control is normally performed by evaluating whether a present rotating speed of the spindle is equal to a specified speed.

10. The method of CLV (Constant Linear Velocity) error recovery in an optical recording/reproducing apparatus according to claim 9, further comprising setting the rotating speed of the spindle using a prepared speed table.

11. The method of CLV (Constant Linear Velocity) error recovery in an optical recording/reproducing apparatus according to claim 10, further comprising storing data positions and speed values equal to corresponding data positions of the spindle in the speed table.

12. The method of CLV (Constant Linear Velocity) error recovery in an optical recording/reproducing apparatus according to claim 10, wherein said rotating speed of the spindle reaches a specified speed stored in the speed table depending on a state of a spindle judgment signal.

13. The method of CLV (Constant Linear Velocity) error recovery in an optical recording/reproducing apparatus according to claim 12, further comprising:
comparing the rotating speed of the spindle sensed by a sensor with a rotating speed of a spindle in the speed table to determine the state of the spindle judgment signal.
